(19) United States
(12) Patent Application Publication
(10) Pub. No.: US 2006/0274068 A1
(43) Pub. Date: Dec. 7, 2006

(54) ADAPTIVE CONTACT BASED SKELETON FOR ANIMATION OF CHARACTERS IN VIDEO GAMES

(75) Inventor: Luc Barthelet, San Francisco, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Electronic Arts Inc., Redwood City, CA (US)

(21) Appl. No.: 11/422,562

(22) Filed: Jun. 6, 2006

Related U.S. Application Data
(60) Provisional application No. 60/687,952, filed on Jun. 6, 2005.

(51) Int. Cl. G06T 15/70

(52) U.S. Cl. 345/473

(57) ABSTRACT

Equilibrium forces and momentum are calculated using character skeleton node graphs having variable root nodes determined in real time based on contacts with fixed objects or other constraints that apply external forces to the character. The skeleton node graph can be traveled backwards and in so doing it is possible to determine a physically possible reaction force. The tree can be traveled one way to apply angles and positions and then traveled back the other way ‘to calculate’ forces and moments. Unless the root is correct, however, reaction forces will not be able to be properly determined. The adaptive skeleton framework enables calculations of reactive forces on certain contact nodes to be made. Calculation of reactive forces enables more realistic displayed motion of a simulated character.

### CROSS-REFERENCES TO RELATED APPLICATIONS

This application claims the benefit of U.S. Provisional Application No. 60/687,952 (Attorney docket No. 019491-010400US), filed Jun. 6, 2005, the disclosure of which is incorporated herein by reference in its entirety.

### BACKGROUND OF THE INVENTION

The present invention relates generally to computer graphics and animation and more particularly to systems and methods for animating computer generated characters in video games.

In computer-generated animation, a character's appearance is generally defined by a three-dimensional computer model. To appear realistic, the computer model of a character is often extremely complex, having many nodes and attributes. Due to the complexity involved with animating such complex models, animation tools often rely on skeleton models and animation variables to define character animation. A skeleton is essentially a representation of a “stick figure” representing the character's pose, or bodily attitude. By moving the skeleton nodes representing body parts based on constraints such as joints and external forces on nodes, the skeleton can be manipulated into a desired pose. Current skeleton model systems typically use a point or node representing the character's center of gravity as the root point for force and motion calculations. As the skeleton is posed, animation tools modify the character model so that the bodily attitude of the character roughly mirrors that of the skeleton.

One type of technology used in many video games as a source of animation for character skeleton models is known as motion capture (mo-cap) technology. Mo-cap data are basically pre-recorded motions that are played back and applied to a character skeleton model to simulate motion of the character. Mo-cap data may provide natural and believable motion, but it tends not to be very dynamic. Typically, mo-cap data is played back exactly as recorded, or slightly modified using blending, warping or other modification techniques. Also, in video games external forces on a skeleton are typically not calculated due to the intense resource (e.g., CPU, GPU and memory management modules) usage that may be required. Rather, kinematic transformations are typically applied to the mo-cap data, e.g., the data may be combined with inverse kinematic (IK) algorithms. However, the animation resulting from such kinematic transformations often appears stiff and “puppet-like.”

Due to the non-dynamic nature of mo-cap replay, game developers are oftentimes forced to prevent or ignore dynamic situations that may occur in real life. Examples in a football video game might include dynamic player-player collisions, dynamic player-player pile-ups and dynamic player tackles. Situations like these are currently typically avoided or handled inadequately resulting in unrealistic animation and game play.

It is therefore desirable to provide systems and methods that provide for unscripted animation which interacts correctly with a dynamic environment. Such systems and methods should allow for accurate and efficient motion calculations based on applied forces external to the character.

### BRIEF SUMMARY OF THE INVENTION

The present invention provides systems and methods for calculating equilibrium forces and momentum using character skeletons having variable root nodes determined in real time based on contacts with fixed objects or other constraints that apply external forces to the character.

Where in video games motion data is usually generated for a skeleton referenced by a root bone to which the spines and then legs and arms are attached, the present invention provides a skeleton framework that is redefined in real time to represent the same character from various skeletons based on the character's attitude and contacts with the (simulated) environment. The variable skeleton enables physical computations of the forces of contact and momentum of each different body piece and a simulation of the movement of the character's body. The skeleton framework, and the calculated forces and momentum of the body parts, can be used for generating animated characters or for modifying pre-animated characters such as mo-cap animations.

In one aspect, the skeleton is defined based on the contacts the character has with the environment. For example, a character in free fall has a skeleton starting at its center of gravity. A character with one foot on the ground has a skeleton starting with that foot. A character with two feet on the ground has a skeleton starting with a ground piece that holds both feet in their position. A character with both feet on the ground and one hand on a support would have a skeleton starting with a ground piece attached to three elements, the two feet and the hand. At each interval of time necessary for simulation of the display, the simulation adapts the skeleton to reflect the number and locations of the contacts with the ground.

According to one aspect of the present invention, a computer-implemented method is provided for calculating forces and momentum for nodes of a simulated character using an adaptive contact-based skeleton node graph. The method typically includes defining a skeleton node graph representing a character for display in a simulated environment, the node graph having a hierarchical node structure, and defining one or more root nodes, wherein a root node represents a node having a point of contact with an object in the simulated environment. The method also typically includes calculating forces and momentum on each node beginning with the root node(s), redefining the one or more root nodes in response to a contact event occurring in the simulated environment, and recalculating the forces and momentum on each node. In certain aspects, the simulated environment is a video game environment.

According to another aspect of the present invention, a computer-implemented method is provided for calculating a zero moment point of a character node for evaluating the dynamic stability of a character in a simulated environment in a videogame. The method typically includes defining a skeleton node graph representing a character for display in a simulated environment, the node graph having a hierarchical node structure, and defining one or more root nodes, wherein a root node represents a node having a point of contact with an object in the simulated environment. The method also typically includes calculating forces and momentum on each node beginning with the root node(s), and determining a point in the node graph at which the total inertia force equals zero. In certain aspects, the simulated environment is a video game environment.

According to yet another aspect of the present invention, a computer-readable medium is provided that stores code for controlling one or more processors to calculate forces and momentum for nodes of a simulated character using an adaptive contact-based skeleton node graph. The code typically includes instructions to define a skeleton node graph representing a character for display in a simulated environment, the node graph having a hierarchical node structure, and to define one or more root nodes, wherein a root node represents a node having a point of contact with an object in the simulated environment. The code also typically includes instructions to calculate forces and momentum on each node beginning with the root node(s), to redefine the one or more root nodes in response to a contact event occurring in the simulated environment, and to recalculate the forces and momentum on each node. In certain aspects, the simulated environment is a video game environment.

Reference to the remaining portions of the specification, including the drawings and claims, will realize other features and advantages of the present invention. Further features and advantages of the present invention, as well as the structure and operation of various embodiments of the present invention, are described in detail below with respect to the accompanying drawings. In the drawings, like reference numbers indicate identical or functionally similar elements.

### BRIEF DESCRIPTION OF THE DRAWINGS

FIG. 1 is a block diagram of typical computer system 100 useful for implementing the motion and force calculation and animation algorithms of the present invention.

FIG. 2 illustrates a skeleton framework starting at a root node.

FIG. 3 illustrates a skeleton framework starting at a node representing a foot (left).

### DETAILED DESCRIPTION OF THE INVENTION

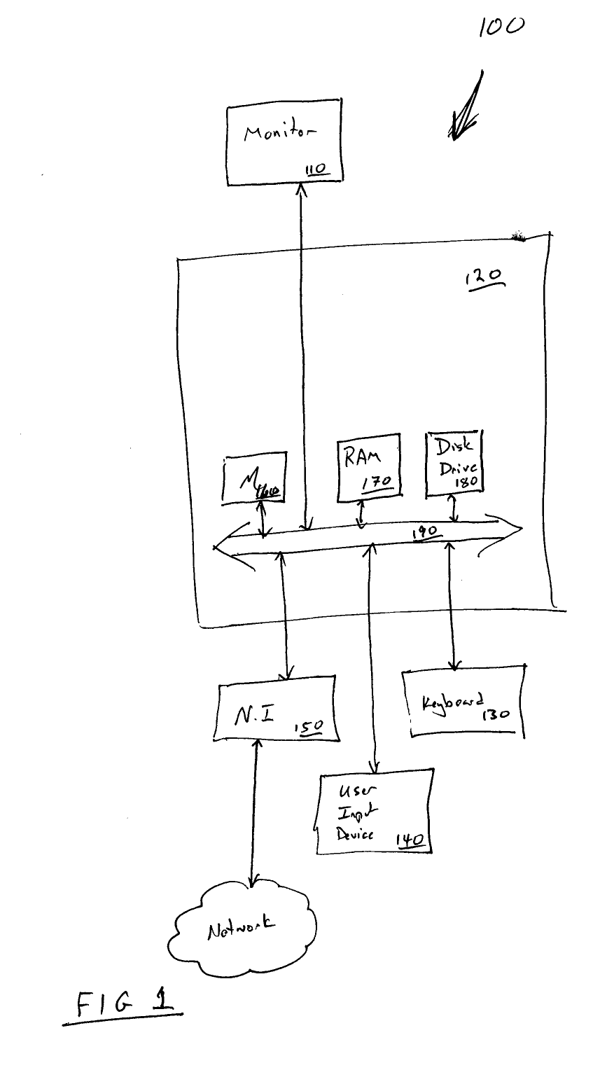

FIG. 1 is a block diagram of typical computer system 100 useful for implementing the motion and force calculation and animation algorithms of the present invention. As shown, computer system 100 typically includes a monitor 110, computer 120, a keyboard 130, a user input device 140, a network interface 150, and the like. User input device 140 is typically embodied as a computer mouse, a trackball, touch screen, pen, track pad, wireless remote, or the like. User input device 140 typically allows a user to enter information and to select objects, icons, text and the like that appear on the monitor 110.

Embodiments of network interface 150 typically include an Ethernet card, a modem (telephone, satellite, cable, ISDN, etc.), (asynchronous) digital subscriber line (DSL) unit, and the like. Network interface 150 is typically coupled to a computer network as shown. In other embodiments, network interface 150 may be physically integrated on the motherboard of computer 120, may be a software program, such as soft DSL, or the like.

Computer 120 typically includes familiar computer components such as a processor 160, and memory storage devices, such as a random access memory (RAM) 170, disk drives 180, and system bus 190 interconnecting the above components. In one aspect, computer 120 is a PC compatible computer having one or multiple microprocessors such as Pentium or Xeon microprocessors from Intel Corporation.

RAM 170 and disk drive 180 are examples of tangible media for storage of data, data structures, audio/video files, computer programs, applet interpreters or compilers, virtual machines, scene descriptor files, object data files, shader descriptors, a rendering engine, output image files, texture maps, displacement maps, object creation environments, animation environments, asset management systems, databases and database management systems, and the like. Other types of tangible computer readable media include floppy disks, removable hard disks, optical storage media such as CD-ROMS, DVDs and bar codes, semiconductor memories such as flash memories, read-only-memories (ROMS), battery-backed volatile memories, networked storage devices, and the like.

In certain aspects, computer system 100 may also include software that enables communications over a network using protocols such as the HTTP, TCP/IP, RTP/RTSP protocols, and the like. Other communications software and transfer protocols may also be used, for example IPX, UDP or the like.

FIG. 1 is representative of computer rendering systems capable of implementing aspects of the present invention. It will be readily apparent to one of ordinary skill in the art that many other hardware and software configurations are suitable for use with the present invention. For example, the use of other microprocessors are contemplated, such as Itanium microprocessors; Opteron or AthlonXP microprocessors from Advanced Micro Devices, Inc; PowerPC G3, G4 or G5 microprocessors from Motorola, Inc.; and the like. Further, other types of operating systems are contemplated, such as Windows operating systems including WindowsXP, WindowsNT, or the like from Microsoft Corporation, Solaris from Sun Microsystems, LINUX, UNIX, MAC OS from Apple Computer Corporation, and the like.

Adaptive Skeleton Calculations

According to one embodiment of the present invention, equilibrium forces and momentum are calculated using character skeleton node graphs having variable root nodes determined in real time based on contacts with fixed objects or other constraints that apply external forces or momentum to the character.

The skeleton node graph can be traveled backwards and in so doing it is possible to determine a physically possible reaction force. The tree can be traveled one way to apply angles and positions and then traveled back the other way ‘to calculate’ forces and moments. Unless the root is correct, however, reaction forces will not be able to be properly determined. According to one embodiment of the present invention, an adaptive skeleton framework is provided that enables calculations of reactive forces and momentum on certain contact nodes to be made. Calculation of reactive forces and momentum enables more realistic displayed motion of a simulated character.

Any system can be described from the center of gravity if the reaction forces of ground are known a priori. Usually video games ignore forces of external contact such as the force of the ground on a character's feet. When a first character is floating in space and a second character (or any object) hits the first character with some force, it is easy to calculate how everything moves, since there is only one force (ignoring any gravitational forces). However, when the first character is standing on the ground, there is the first force (known) and a reaction force of the ground opposing the movement of the first character's feet. The reaction force is defined as a sufficient opposing force that would maintain the attached node in place. That reaction force (and momentum) is not known until all of the other node movements are calculated because the reaction force is equal to “whatever it takes to keep the feet in place.”

According to the present invention, momentum is calculated by traversing a skeleton node graph in a node order starting with nodes/points in contact with ground (or other constraints that apply a physical force on a skeleton node, e.g., a node contacting a fixed object such as ground or a wall, or in contact with another character or other object).

A typical calculation starts with a root node in the skeleton and works down the tree, identifying angles, positions and velocities. Then, the calculation works its way back up the tree calculating forces and moments. External forces and momentum applied to the (root) node are used in the calculation. For example, a bullet striking a character imparts a force and momentum to the contact node, e.g., mass of bullet×velocity of bullet.

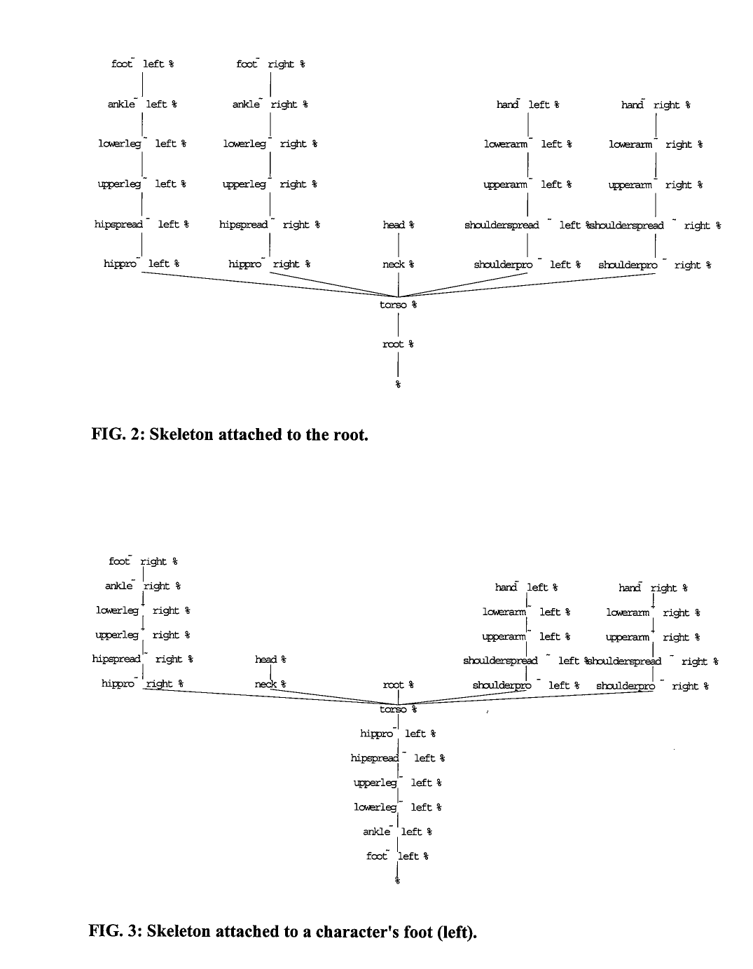

FIG. 1 shows a skeleton (tree) representing a character in free fall, e.g., having the center of gravity as the root node. FIG. 2 shows a skeleton (tree) representing a character having its left foot in contact with ground (e.g., walking, running, or standing on one leg) where the left foot is the root node. To determine the reaction force of the ground (or more generally any fixed object to which the character is currently attached), the tree should start with the feet (or more generally, the skeleton node(s) connected to the fixed object(s)).

According to one aspect of the present invention, the root of the tree is defined to be a fixed object or multiple fixed objects. The root (fixed object(s)) may change as the character moves. For example, as a character walks, the fixed object for which the root of the tree is associated may change between the right foot and the left foot.

Because the skeleton is a graph with nodes representing body parts (e.g., bones, etc.) and edges indicating node connectors (e.g., joints) and other constraints, as can be seen in FIGS. 1 and 2, each skeleton is defined based on the contacts the character has with the environment. A character in free fall has a skeleton starting at its center of gravity (FIG. 1). A character with one foot on the ground has a skeleton starting with that foot (FIG. 2). A character with two feet on the ground has a skeleton starting with a ground piece that holds both feet in their position. A character with both feet on the ground and one hand on a support would have a skeleton starting with a ground piece attached to three elements, the feet and the hand. At each interval of time necessary for the simulation of the display, the simulation adapts the skeleton to reflect the number and locations of the contacts with the ground. In one aspect, the simulation adapts the skeleton at each rendering interval. However, in preferred aspects, the simulation adapts the skeleton each time that a contact event occurs. A contact event may be an event that causes the connection between a skeleton node and the external world to change. For example, for a character walking, with the feet changing places, a contact event may be considered the placement or removal of a foot from ground. Likewise a bullet, or other external object such as another character, striking the character may be considered a contact event.

According to one aspect, the skeleton node tree is traversed and actual force and momentum calculations are made following a recursive Newton-Euler formulation of the equations of motion (rotational and translational motion). An example of the Newton-Euler formulation can be found in Chapter 4, and in particular chapter 4.5, of Modelling and Control of Robot Manipulators, L. Sciavicco and B. Siciliano, 1996, which is incorporated herein by reference. However, it should be appreciated that the Lagrange formulation of the dynamic model of motion may also be implemented. According to one aspect, pseudo-code for recursively calculating forces and moments represented in MATHEMATICA code follows:

```
UpdateRenderDataRobot[matrix, origin, rootName, “”, FinalRobotAngleData, { },1,
renderFlags];
UpdateRenderDataRobot[matrix_, origin_, boneName_, fromBoneName_, angleData_,
accVector_, IterDepth_, debugFlagAlpha_:{ }] := Module[{
boneIndex, (* where boneName is in RenderDataRobot *)
animMatrix, boneMatrix, childOrigin,
zChildRotMatrix,
coordMatrix, SkeletonData, theAngle, coordOrigin, childBoneIndex,
newAngleSpeed, newAngleAcceleration,
localPosition, localAccelerationVector, localRotationalAcceleration,
localRotationalSpeed, localSpeed, rotationAxis,
force, moment, childForce, childMoment,
thisChildAccVector, debugFlag,
childListWithSkeletonData, validChildren,
parentLink, CGPosition, CG2ParentLink
},
(* some extra level of filtering for debugging *)
debugFlag = debugFlagAlpha;
(* description of the structure of the returned value: { force , moment } *)
(* some code run as initialisation *)
If[IterDepth == 1,
    COGData = { };
    ForceGraphics = { };
];
(* RobotAngleData is a global tracking angles, their speed and acceleration over time *)
RobotAngleData = angleData;
(* matrix is the spatial orientation of the current element *)
(* unless it is root which is a special case *)
If[boneName == robotSkeletonStartingNode, boneIndex = Position[RenderDataRobot,
    boneName][[1, 1]];
        RenderDataRobot[[boneIndex, RDChildOriginIndex]] = origin;
        RenderDataRobot[[boneIndex, RDBoneMatrixIndex]] = matrix;
];
SkeletonData =
Select[robotskeleton, #[[SkelBoneNameIndex]] == boneName &][[1]];
coordMatrix = SkeletonData[[SkelMatrixIndex]];
parentLink = Select[ SkeletonData[[SkelChilListIndex]], fromBoneName ==
    #[[linkBoneNameIndex]] &] ;
If[ parentLink != { },
    coordOrigin = parentLink[[1, linkPositionIndex]];,
    coordOrigin = {0, 0, 0};
];
If[ MemberQ[debugFlag, boneName ],
  Print[“parent name= ”, boneName, “\n origin=”, origin, “\n matrix= ”, matrix, “\n
coordOrigin=”, coordMatrix.coordOrigin, “\ncoordMatrix=”, coordMatrix];
];
(* The mental model for this code is that the parent piece sets the children's rotations and then
calls each one of them. *)
(* calculating the forces *)
(* Init the values that will traverse the chain *)
(* CGPosLocal is the position to the center of Gravity from the parentlink in corrected
coordinates *)
CGPosition = coordMatrix.(SkeletonData[[SkelInertiaListDataIndex,
    SkelInertiaCGPosIndex]]);
CG2ParentLink = localPosition = coordMatrix.(SkeletonData[[SkelInertiaListDataIndex,
    SkelInertiaCGPosIndex]] − coordOrigin);
localAccelerationVector = {0, 0, 0}; localRotationalAcceleration = {0, 0, 0};
localRotationalSpeed = {0, 0, 0}; localSpeed = {0, 0, 0};
n = 0;
Map[(
    localPosition = #[[matrixIndex]].(localPosition);
    localRotationalAcceleration = #[[matrixIndex]].localRotationalAcceleration +
        #[[rotationalAccelerationIndex]]* #[[axisIndex]] ;
    localRotationalSpeed = #[[matrixIndex]].localRotationalSpeed +
        #[[rotationSpeedIndex]];
    localAccelerationVector = #[[matrixIndex]].localAccelerationVector +
    (* tangential from this rotation *) Cross[#[[rotationalAccelerationIndex]]*
        #[[axisIndex]] , localPosition ] +
(* normal from this rotation \[Omega]\hat{ }2R *) − (localPosition − (localPosition. #[[axisIndex]])
        #[[axisIndex]])( #[[rotationSpeedIndex]]*#[[rotationSpeedIndex]])
(* coriolis *) + 2*Cross[#[[ rotationSpeedIndex ]]* #[[axisIndex]],
#[[matrixIndex]].localSpeed ];
localSpeed = #[[matrixIndex]].localSpeed + Cross[#[[ rotationSpeedIndex ]]* #[[axisIndex]],
        localPosition ];
localPosition += #[[ originIndex ]];
) &, Reverse[accVector]];
(* init the forces calculations *)
force = {0, 0, 0}; moment = {0, 0, 0};
(* use TreeRobot to figure out which Childrens are valid *)
validChildren = findChildrenRobot[boneName];
(* get the structure from skeleton that match the valid children *)
childListWithSkeletonData = Select[SkeletonData[[SkelChilListIndex]],
        MemberQ[validChildren, #[[linkBoneNameIndex]]] &];
(* recursively go through the children *)
Map[( (* # -> {linkBoneNameIndex, linkPositionIndex, linkZAxisIndex,
        linkZeroRotIndex, linkFlagIndex} *)
childBoneIndex = Position[RenderDataRobot, #[[linkBoneNameIndex]] ][[1, 1]];
childOrigin = Chop[origin + matrix.( coordMatrix.(#[[linkPositionIndex]] − coordOrigin))];
        theAngle = (GetAngleForRobotAxis[#[[linkAngleName]], 0]) degrees;
(* update RobotAngleData with angle, speed and acc *)
{newAngleSpeed, newAngleAcceleration} = RecordSpeedAccData[#[[linkAngleName]],
theAngle, CurrentRobotTime];
zChildRotMatrix = BuildVectorBase[coordMatrix.#[[linkZAxisIndex]] ];
animMatrix = Chop[ Transpose[zChildRotMatrix].Rotz[theAngle].zChildRotMatrix ];
rotationAxis = Chop[matrix.coordMatrix.#[[linkZAxisIndex]] ];
boneMatrix = Chop[matrix.animMatrix];
RenderDataRobot[[childBoneIndex]] = {childOrigin, boneMatrix, origin, rotationAxis,
    #[[linkBoneNameIndex]]};
thisChildAccVector = Append[accVector, {coordMatrix.#[[ linkPositionIndex ]] (* origin *),
    animMatrix (* new orientation *),
        coordMatrix.#[[ linkZAxisIndex ]] (* axis *),
        newAngleSpeed (* angular velocity *),
        newAngleAcceleration (* angular acceleration *)
                }
            ];
(* the recursion call *)
{childForce, childMoment} =
    UpdateRenderDataRobot[ boneMatrix,
                childOrigin,
                #[[linkBoneNameIndex]],
                boneName,
                RobotAngleData,
                thisChildAccVector,
                IterDepth + 1 ,
                debugFlagAlpha
                ];
(* corrects to the current parent referencial *)
childForce = animMatrix.childForce;
childMoment = animMatrix. childMoment;
If[MemberQ[debugFlag,“debugForce”], Print[boneName, “ IterDepth=“, IterDepth,” ”];
  PrintSymbol[childForce] ; PrintSymbol[CGPosition]; Print[“child Position − CG =”,
  coordMatrix.#[[linkPositionIndex]] − CGPosition ]; ];
force += childForce;
moment += childMoment + Cross[childForce, coordMatrix.#[[linkPositionIndex]] −
    CGPosition ];
) & , childListWithSkeletonData ] ;
(* now add all the external forces applied to this link, each external force has a strength,
moment and position relative to CG *)
Map[
( force+= #[[forceStrengthIndex]];moment +=
#[[momentIndex]]+Cross[#[[force]],coordMatrix.#[[forcePositionIndex]]−CGPosition ];
)&, ExternalForces];
(* now correct the force for the local values *)
force += − SkeletonData[[SkelInertiaListDataIndex, SkelInertiaMassIndex]]*
    ( Transpose[matrix].({0, 0, 9.81} + localAccelerationVector));
moment += Cross[force, CG2ParentLink] + SkeletonData[[SkelInertiaListDataIndex,
        SkelInertiaMatrixIndex]] .(Transpose[matrix].localRotationalAcceleration)
(* + Cross[Transpose[matrix].localRotationalSpeed, testMass[[iterDepth, massDataIndex,
massIMatrix]] .Transpose[matrix].localRotationalSpeed] *);
COGData = Append[COGData, {SkeletonData[[SkelInertiaListDataIndex,
    SkelInertiaMassIndex]], localPosition}];
GlobalCOG = origin + matrix.CG2ParentLink;
Chop[{ force , moment }]
];
```

According to one embodiment, the zero moment point (ZMP) of the node graph is calculated. The ZMP specifies the point with respect to which dynamic reaction force at the contact point with the external environment (e.g., contact of a foot or feet with the ground) does not produce any moment, i.e. the point where total inertia force equals 0 (zero). The Newton-Euler equations are used to calculate the ZMP of the character to evaluate the dynamic stability of the character and determine its stability for the current skeleton. The ZMP may correspond to a node, or to a point in between nodes.

A discussion of the principals of zero moment point can be found in Philippe Sardain and Guy Bessonnet, Forces Acting on a Biped Robot, Center of Pressure—Zero Moment Point, IEEE Trans. Systems, Man, and Cybernetics—Part A. Vol. 34, No. 5, pp. 630-637, 2004, and Vukobratović, Miomir and Borovac, Branislav, Zero-moment point—Thirty five years of its life, International Journal of Humanoid Robotics, Vol. 1, No. 1, pp. 157-173, 2004, both of which are hereby incorporated by reference. Below is an example of Mathematica code for the calculation of the ZMP according to an aspect of the present invention.

calculateZMP[{force_, moment_}] :=
Module[{ZMPLocX, ZMPLocY, zmpLocation, sol},
sol = Solve[
Take[Cross[force, {ZMPLocX, ZMPLocY, groundAltitude }], 2] ==
Take[moment, 2], {ZMPLocX, ZMPLocY}];
If[Length[sol] > 0,
zmpLocation = {ZMPLocX, ZMPLocY, groundAltitude} /. sol[[1]],
Print[“force=”, force];
Print[“moment=”, moment];
Print[Cross[force, {ZMPLocX, ZMPLocY, groundAltitude}]];
Print[moment * {1, 1, 0}];
Print[“sol=“, sol];
{ }]
];
calculateZMP::usage = “calculateZMP[{force, moment}]”;

In certain aspects, the force and momentum calculation processes, the ZMP calculation processes and the animation processes of the present invention are coded in C, C++, VisualBasic, or any other computer language suitable for use in video games or other character animation systems.

While the invention has been described by way of example and in terms of the specific embodiments, it is to be understood that the invention is not limited to the disclosed embodiments. To the contrary, it is intended to cover various modifications and similar arrangements as would be apparent to those skilled in the art. Therefore, the scope of the appended claims should be accorded the broadest interpretation so as to encompass all such modifications and similar arrangements.

What is claimed is:

1. A computer-implemented method of calculating forces and momentum for nodes of a simulated character using an adaptive contact-based skeleton node graph, the method comprising;
defining a skeleton node graph representing a character for display in a simulated environment, said node graph having a hierarchical node structure;
defining one or more root nodes, wherein a root node represents a node having a point of contact with an object in the simulated environment;
calculating forces and momentum on each node beginning with the root node(s);
redefining the one or more root nodes in response to a contact event occurring in the simulated environment; and
recalculating the forces and momentum on each node.

2. The method of claim 1, wherein calculating and recalculating are performed recursively using Newton-Euler equations of motion beginning at a root node.

3. The method of claim 1, wherein calculating and recalculating include recursively determining forces and moments on the nodes of the graph beginning at each defined root node.

4. The method of claim 3, wherein recursively determining includes:
traversing the hierarchical graph beginning at a root node to determine angles, positions and/or velocities of each node in the graph; and
traversing the graph back to the root node to determine forces and momentum on each node.

5. The method of claim 1, further comprising rendering a display of the character in the simulated environment based on the forces and momentum calculated for each node.

6. The method of claim 1, wherein a contact event includes a node making contact with an external element in the simulated environment or a root node losing contact with an external element.

7. The method of claim 1, wherein if no node in the graph has a point of contact with an external object in the simulated environment, a root node is defined as a node representing the center of gravity of all nodes.

8. The method of claim 1, wherein an external object in the simulated environment includes one of another character and an inanimate object.

9. The method of claim 8, wherein an inanimate object is an object that imparts force and/or momentum on one or more nodes of the simulated character.

10. The method of claim 1, wherein a node represents a part of the body of the character.

11. The method of claim 1, wherein the simulated environment is a video game environment.

12. A computer-implemented method of calculating a zero moment point of a character node for evaluating the dynamic stability of a character in a simulated environment in a videogame, the method comprising:
defining a skeleton node graph representing a character for display in a simulated environment, said node graph having a hierarchical node structure;
defining one or more root nodes, wherein a root node represents a node having a point of contact with an object in the simulated environment;
calculating forces and momentum on each node beginning with the root node(s); and
determining a point in the node graph at which the total inertia force equals zero.

13. The method of claim 12, further including rendering a display of the character in the simulated environment based on the forces and momentum calculated for each node.

14. The method of claim 12, wherein the simulated environment is a video game environment.

15. The method of claim 12, further comprising using the determined point to determine the stability of the skeleton.

16. A computer-readable medium storing code for controlling one or more processors to calculate forces and momentum for nodes of a simulated character using an adaptive contact-based skeleton node graph, wherein the code includes instructions to:
define a skeleton node graph representing a character for display in a simulated environment, said node graph having a hierarchical node structure;
define one or more root nodes, wherein a root node represents a node having a point of contact with an object in the simulated environment;
calculate forces and momentum on each node beginning with the root node(s);
redefine the one or more root nodes in response to a contact event occurring in the simulated environment; and
recalculate the forces and momentum on each node.

17. The computer-readable medium of claim 16, wherein the simulated environment is a video game environment.

18. The computer-readable medium of claim 16, wherein the instructions to calculate and recalculate include instructions to apply Newton-Euler equations of motion beginning at a root node.

19. The computer-readable medium of claim 16, wherein the instructions to calculate and recalculate include instructions to recursively determine forces and moments on the nodes of the graph beginning at each defined root node.

20. The computer-readable medium of claim 19, wherein the instructions to recursively determine include instructions to:
traverse the hierarchical graph beginning at a root node to determine angles, positions and/or velocities of each node in the graph; and
traverse the graph back to the root node to determine forces and momentum on each node.

21. The computer-readable medium of claim 16, wherein a contact event includes a node making contact with an external element in the simulated environment or a root node losing contact with an external element.

22. The computer-readable medium of claim 16, wherein the code further includes instructions to render a display of the character in the simulated environment based on the forces and momentum calculated for each node.

23. The computer-readable medium of claim 16, wherein a node represents a part of the body of the character.

24. The computer-readable medium of claim 16, wherein if no node in the graph has a point of contact with an external object in the simulated environment, a root node is defined as a node representing the center of gravity of all nodes.

25. The computer-readable medium of claim 16, wherein an external object in the simulated environment includes one of another character and an inanimate object.

26. The computer-readable medium of claim 25, wherein an inanimate object is an object that imparts force and/or momentum on one or more nodes of the simulated character.
